(19) United States
(12) Patent Application Publication
(10) Pub. No.: US 2010/0007593 A1
(43) Pub. Date: Jan. 14, 2010

(54) LIQUID CRYSTAL DISPLAY UNIT DRIVEN IN A LONGITUDINAL-ELECTRIC-FIELD MODE

(75) Inventors: Kenichi Mori, Kawasaki (JP); Ken Sumiyoshi, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD Technologies, Ltd., Kawasaki (JP)

(21) Appl. No.: 12/499,323

(22) Filed: Jul. 8, 2009

(30) Foreign Application Priority Data
Jul. 9, 2008 (JP) 2008-179266

(51) Int. Cl. G09G 3/36; G02F 1/133

(52) U.S. Cl. 345/94; 349/33

(57) ABSTRACT

A LCD unit includes a drive unit that drives a LC layer in at least a part of a unit pixel by applying thereto a longitudinal electric field. The drive unit drives the at least a part of the unit pixel in an image period by applying thereto an image voltage corresponding to an image, and in a preliminary period preceding to the image period by applying a preliminary voltage equal to or higher than a threshold voltage that allows LC molecules in the LC layer to start change of orientation of the LC molecules.

This application is based upon and claims the benefit of priority from Japanese patent application No. 2008-179266 filed on Jul. 9, 2008, the disclosure of which is incorporated herein in its entirety by reference.

### TECHNICAL FIELD

The present invention relates to a liquid crystal display (LCD) unit and, more particularly, to a LCD unit including an array of unit pixels at least some of which is driven in a longitudinal-electric-field mode. The present invention also relates to a method for driving such a LCD unit, and a terminal device including such a LCD unit.

### BACKGROUND ART

There is a LCD unit known as a transflective LCD unit that has the function of both a transmissive LCD unit and a reflective LCD unit (for example, refer to Patent Publication-1). The transflective LCD unit has a transmissive area and a reflective area in each of an array of unit pixels defined therein. The transmissive area passes therethrough light emitted from a backlight source, and uses the backlight source as a light source for display of an image. The transmissive area has a superior image quality in a relatively dark environment such as in the interior of a room, or a darkroom. The reflective area includes a reflective film and uses the external light reflected by the reflective film as a light source for display of an image. The reflective area has a superior image quality in a relatively bright environment such as outdoors. Since the LCD unit provided in a portable device (terminal device), such as a mobile telephone or a PDA (personal digital assistant), is used in a variety of environments from outdoors to the darkroom, the transflective LCD unit is generally employed as a LCD unit in the portable device. The backlight source can be turned OFF, if desired, in the transflective LCD unit to achieve a lower power dissipation.

The LCD unit can be operated in a lateral-electric-field mode such as FFS (field-fringe-switching) mode or IPS (in-plane-switching) mode for display of an image. This lateral-electric-field-mode LCD unit includes a pixel electrode and a common electrode both formed on the same substrate. The lateral-electric-field-mode LCD unit supplies a potential difference between the pixel electrode and the common electrode, to apply a lateral electric field to the liquid crystal (LC) layer, whereby LC molecules in the LC layer are rotated in a plane parallel to the substrate for display of the image. The lateral-electric-field-mode LCD unit has a wider viewing-angle characteristic as compared to a TN (twisted nematic)-mode LCD unit.

A transflective LCD unit that operates in the lateral-electric-field mode is reported (for example, refer to Patent Publication-2). The transflective lateral-electric-field-mode LCD unit has a wider viewing-angle characteristic in the transmissive area, and yet may have a poor contrast ratio in the reflective area. More specifically, if the reflective area of the transflective LCD unit is driven in a normally-white IPS mode, a portion of the LC layer within the gap between the pixel electrode and the common electrode formed on the same substrate is driven by the lateral electric field to assume a dark state, or provide a dark image. However, another portion of the LC layer overlapping the pixel electrode and the common electrode is not applied with the lateral electric field, to pass therethrough a leakage light due to the disturbance of orientation of the LC molecules. The leakage light passing through the another portion of LC layer overlapping the pixel electrode and common electrode raises the brightness upon display of the dark image (referred to simply as “black-image brightness” hereinafter), to degrade the contrast ratio.

In order to suppress degradation of the contrast ratio of the reflective area, a transflective LCD unit including a reflective area that operates in a homogeneous ECB (electrically-controlled birefringence) mode is reported (for example, refer to Non-patent literature-1). FIGS. 22 and 23 show a section of the LC panel of this transflective LCD unit. The LCD unit includes a first substrate 3, a second substrate 4, and a LC layer sandwiched therebetween and including therein LC molecules 11. The first substrate 3 includes a reflective-area common electrode 8 and an underlying buried retardation film 10 in a reflective area 2. The second substrate 4 includes a reflective-area pixel electrode 7 and an underlying reflective film 9 in the reflective area 2, and includes a transmissive-area pixel electrode 5 and a transmissive-area common electrode 6 in the transmissive area 1.

In the reflective area 2, the reflective-area common electrode 8 formed on the first substrate 3 and the reflective-area pixel electrode 7 formed on the second substrate 4 generate therebetween a longitudinal electric field, which rotates the LC molecules 11 toward the longitudinal direction, i.e., perpendicular to both the substrates, as shown in FIG. 23. On the other hand, the transmissive-area common electrode 6 and transmissive-area pixel electrode 5 formed on the second substrate 4 generate therebetween a lateral electric field, which rotates the LC molecules 11 in the direction parallel to both the substrates.

FIG. 22 shows the state where the longitudinal electric field is not generated in the reflective area 2. In this state of absence of the longitudinal electric field, the LC molecules 11 are oriented in the lateral direction. External light passed by a polarizing film (not shown) disposed on the side of the first substrate 3 far from the LC layer assumes a linearly-polarized light, which is converted into a circularly-polarized light upon passing through the buried retardation film 10. The circularly-polarized light is incident onto the LC layer, converted by the LC layer into a linearly-polarized light due to birefringence anisotropy of the LC layer, and reaches the reflective film 9. The light reflected by the reflective film 9 passes through the LC layer, is converted thereby into a circularly-polarized light, passes through the buried retardation film 10, and is converted into a linearly-polarized light. Since the polarization direction of this linearly-polarized light is parallel to the light transmission axis of the polarizing film, the reflected light passes through the polarizing film to thereby assume a bright state, i.e., provide a white image.

FIG. 23 shows the state where the longitudinal electric field is applied in the reflective area 2. When the longitudinal electric field is applied, the LC molecules 11 are oriented in the longitudinal direction. When the LC molecules 11 are oriented in the longitudinal direction, the LC layer scarcely has a birefringence anisotropy, whereby the incident light passed by the buried retardation film 10 reaches the reflective film 9 as a circularly-polarized light. The circularly-polarized light reflected by the reflective film 9 has an inverted polarization direction, passes through the buried retardation film 10, and is converted into a linearly-polarized light having a polarization direction perpendicular to the light transmission axis of the polarizing film. Thus, the reflected light from the reflective film 9 cannot pass through the polarizing film to provide a black image. The LCD unit having the configuration shown in FIGS. 22 and 23 can control the leakage light caused by the disturbance of orientation of the LC molecules and might be observed in the case of the lateral-electric-field mode, because the reflective area 2 operates in the longitudinal-electric-field mode.

### Related Literatures

Patent Publication-1: JP-2003-344837A

Patent Publication-2: JP-2007-41572A

Patent Publication-3: JP-8-146386A

Non-patent literature-1: “SID INTERNATIONAL SYMPOSIUM DIGEST OF TECHNICAL PAPERS”, SOCIETY FOR INFORMATION DISPLAY, issued in 2007, VOL. 38; NUMB-2, pp 1270-1273

In the above transflective LCD unit shown in FIGS. 22 and 23, the transmissive area is driven in the lateral-electric-field mode. In order to obtain a wider viewing-angle characteristic in the lateral-electric-field mode, it is preferable that the LC molecules have a smaller pretilt angle. This is because a slanted viewing direction upon observing the LCD unit causes variation of brightness, during display of a dark state, depending on the viewing angle. This narrows the viewing angle that can provide a superior image. In general, the pretilt angle of the transmissive LCD unit operating in the lateral-electric-field mode is set at 0.5 degree or smaller.

On the other hand, for the longitudinal-electric-field mode such as TN- or ECB-mode, it is preferable that the LC molecules have a larger pretilt angle. This is because a smaller pretilt angle may involve occurrence of a disclination in a vicinity of the pixel electrode. The vicinity of the pixel electrode is generally associated with a lateral electric field between the same and an adjacent pixel electrode, in addition to the longitudinal electric field. Further, a slanted electric field is also generated between the reflective-area common electrode 8 formed on the first substrate 3 and the transmissive-area pixel electrode 5 and transmissive-area common electrode 6 both formed on the second substrate 4. These lateral electric field and slanted electric field may reverse the tilt direction of the LC molecules, to thereby generate a reverse tilt. The reverse tilt, if occurs, causes the LC molecules to stay in the lateral direction although the LC molecules are designed to rise (changes orientation thereof) in the longitudinal direction due to the longitudinal electric field.

In a normally white mode of the LCD unit, the reverse tilt causes occurrence of a bright line during display of a black image. Thus, a black matrix is provided on the first substrate 3 for shielding the bright line. However, since location of the bright line is not uniquely fixed, the black matrix may have a larger area if it is desired to completely shield the bright line. The larger area of the black matrix reduces the effective opening area of each pixel, to reduce the brightness of the image. It is ordinary for the LCD unit to have a pretilt angle of 3 degrees or larger in order to suppress the reverse tilt therein.

In addition, in order for the reflective area 2 to operate in the longitudinal-electric-field mode, a larger pretilt angle is required in some cases. FIG. 24 shows the detail of section of the reflective area 2 of a unit pixel on the second substrate 4. The reflective film 9 has a concave-convex (uneven) surface for diffusing the light while reflecting the same. The average slanted angle of the reflective film 9, which is an index of the uneven surface, is about 6-9 degrees. A larger average slanted angle corresponds to an acute uneven surface, whereas a smaller average slanted angle corresponds to a dull uneven surface, i.e., a smoother surface. The reflective film 9 is generally covered by an overlying insulating film 12, which acts as a planarization film. The reflective-area pixel electrode 7 is formed on the insulating film 12. The average slanted angle of surface of the insulating film 12 that affects the orientation of LC molecules is about 2 degrees. Since the slanted surface of the insulating film 12 has a variety of directions and a variety of heights, the LC molecules in the vicinity of the insulating film 12 have an unstable orientation direction. This may cause a smaller pretilt angle of the LC molecules in the vicinity of the insulating film 12, and involve a reverse tilt due to the smaller pretilt angle.

As described heretofore, it is desirable that the LC molecules have a smaller pretilt angle in the transmissive area, and a larger pretilt angle in the reflective area. However, it is generally difficult to provide a difference in the pretilt angle between the transmissive area and the reflective area by using an ordinary rubbing treatment or orientation processing of the substrates. Since the transflective LCD unit is typically used in the state of using the backlight source, the transmissive area is prioritized over the reflective area. Thus, the rubbing treatment is conducted so that a lower pretilt angle is employed for the purpose of obtaining a wider viewing angle in the transmissive area, whereby a possibility arises that the reflective area suffers from occurrence of the reverse tilt due to the lower pretilt angle, to have a lower image quality.

There is a known technique wherein a third electrode is provided in addition to the pixel electrode and common electrode, and supplied with a voltage different from the voltages supplied to the pixel electrode and common electrode, to thereby prevent occurrence of the reverse tilt in the longitudinal-electric-field mode (refer to Patent Publication-3, for example). In the LCD unit described in this publication, the third electrode is supplied with the voltage so that a voltage difference appears in the LC layer at any time between the third electrode and the common electrode opposing each other. The LC molecules located near the gap between adjacent two pixel electrodes rise at any time, thereby affecting operation of the LC molecules located near the pixel electrodes. This prevents the undesirable stay of the LC molecules in the lateral direction that is caused by the reverse tilt when the LC molecules are applied with the longitudinal electric field generated between the pixel electrode and the common electrode. That is, the bright line caused by the disclination is prevented.

Use of the technique of Patent Publication-3 in the transflective LCD unit can suppress the reverse tilt in the vicinity of the pixel electrode even when the reflective area has a smaller pretilt angle. However, the use of the third electrode requires a black matrix that shields a reflected light from the third electrode, thereby reducing the effective opening area of the pixel. In addition, the third electrode supplied with a signal different from the signals supplied to the pixel electrode and common electrode increases the time constant due to the parasitic capacitance formed between the third electrode and the common electrode or data line. This causes variation in the image as well as an increase in the power dissipation. Further, the third electrode, which can be provided only in the vicinity of the pixel electrode, cannot prevent occurring of the reverse tilt at the location far from the pixel electrode due to the uneven surface of the reflective film.

It is an object of the present invention to provide a LCD unit wherein at least a part of the pixel is driven in the longitudinal electric field and is capable of suppressing the reverse tilt in the part driven in the longitudinal electric field. It is another object of the present invention to provide a method for driving such a LCD unit and a terminal unit including such a LCD unit.

The present invention provides, in a first aspect thereof, a liquid crystal display unit (LCD) including: a liquid crystal (LC) layer; first and second substrates sandwiching therebetween the LC layer to define an array of unit pixel; and a drive unit that drives the LC layer in at least a part of the unit pixel by applying thereto a longitudinal electric field generated between the first substrate and the second substrate, wherein: the drive unit drives the at least a part of the unit pixel in an image period by applying thereto an image voltage corresponding to an image, and in a preliminary period preceding to the image period by applying thereto a preliminary voltage equal to or higher than a threshold voltage that allows LC molecules in the LC layer to start change of orientation of the LC molecules.

The present invention provides, in a second aspect thereof, a liquid crystal display unit (LCD) including: a liquid crystal (LC) layer; first and second substrates sandwiching therebetween the LC layer to define an array of unit pixel; and a drive unit that drives the LC layer in at least a part of the unit pixel by applying a longitudinal electric field generated between the first substrate and the second substrate, wherein: the drive unit drives the at least a part of the unit pixel in an image period by applying thereto an image voltage corresponding to an image, and maintains in the image period a voltage applied to the at least a part of the unit pixel at a threshold voltage that allows LC molecules in the LC layer to start change of orientation of the LC molecules or higher than the threshold voltage.

The present invention provides, in a third aspect thereof, a method for driving a liquid crystal display unit that includes first and second substrates sandwiching therebetween a liquid crystal (LC) layer and define an array of unit pixel, the method including: driving the LC layer in at least a part of the unit pixel by applying thereto a longitudinal electric field generated between the first substrate and the second substrate; and driving the at least a part of the unit pixel in an image period by applying thereto an image voltage corresponding to an image, and in a preliminary period preceding to the image period by applying thereto a preliminary voltage equal to or higher than a threshold voltage that allows LC molecules in the LC layer to start change of orientation of the LC molecules.

The present invention provides, in a fourth aspect thereof, a method for driving a liquid crystal display unit that includes first and second substrates sandwiching therebetween a liquid crystal (LC) layer and define an array of unit pixel, the method including: driving the LC layer in at least a part of the unit pixel by applying thereto a longitudinal electric field generated between the first substrate and the second substrate, wherein: driving the at least a part of the unit pixel in an image period by applying thereto an image voltage corresponding to an image; and maintaining in the image period a voltage applied to the at least a part of the unit pixels at a threshold voltage that allows LC molecules in the LC layer to start change of orientation of the liquid crystal molecules or higher than the threshold voltage.

The above and other objects, features and advantages of the present invention will be more apparent from the following description, referring to the accompanying drawings.

### BRIEF DESCRIPTION OF THE DRAWINGS

FIG. 1 is a block diagram showing an example of the LCD unit according to the present invention.

FIG. 2 is a time chart showing a first example of the voltage applied to the LC layer in the LCD unit of FIG. 1.

FIG. 3 is a time chart showing a second example of the voltage applied to the LC layer in the LCD unit of FIG. 1.

FIG. 4 is a schematic sectional view showing the orientation of LC molecules applied with a longitudinal electric field during operation in the ECB mode.

FIG. 5 is a schematic sectional view showing the orientation of LC molecules during occurring of a reverse tilt.

FIGS. 6A and 6B are sectional views showing the orientation of LC molecules during application of the threshold voltage (Vth) and a voltage for display of a dark image, respectively.

FIG. 7 is a sectional view showing the orientation of LC molecules applied with a longitudinal electric field during operation in a VA mode.

FIGS. 8A and 8B are sectional views showing the orientation of LC molecules applied with the threshold voltage and a voltage for display of a bright image, respectively.

FIG. 9 is a sectional view of a LC panel provided in a transflective LCD unit.

FIG. 10 is a top plan view showing a vicinity of the boundary between the reflective area and the transmissive area.

FIG. 11 is a top plan view showing a unit pixel formed in the LC panel of a LCD unit according to a first exemplary embodiment of the present invention.

FIG. 12 is a sectional view of the unit pixel taken along line A-A′ in FIG. 11.

FIG. 13 is an explanatory diagram showing the structure of reflective area and the polarization of light passing through each layer in the reflective area.

FIG. 14 is an explanatory diagram showing the structure of transmissive area and the polarization of light passing through each layer in the transmissive area.

FIG. 15 is a time chart showing the potential of each part in the reflective area.

FIG. 16 is a graph showing the relationship between the applied voltage and the tilt angle of the LC molecules as well as the reflectance of the reflective area.

FIG. 17 is a graph showing the relationship similar to the relationship shown in FIG. 16 in the case of a specific retardation of the LC layer.

FIG. 18 is a time chart showing the potential of each part in the reflective area in a LCD unit according to a second exemplary embodiment of the present invention.

FIG. 19 is a time chart showing the potential of each part in the transmissive area in the LCD unit of the second exemplary embodiment.

FIGS. 20A and 20B are time charts showing the potential of each part in the case of inversion of the potential of transmissive-area common electrode in a preliminary period.

FIGS. 21A and 21B are time charts showing the potential of each part in the case of providing no preliminary period in the transmissive area.

FIG. 22 is a sectional view showing a transflective LCD unit described in a publication during absence of the applied voltage.

FIG. 23 is a sectional view of the transflective LCD unit of FIG. 22 during presence of the applied voltage.

FIG. 24 is a sectional view showing a reflective area in another transflective LCD unit described in a publication.

### EXEMPLARY EMBODIMENTS

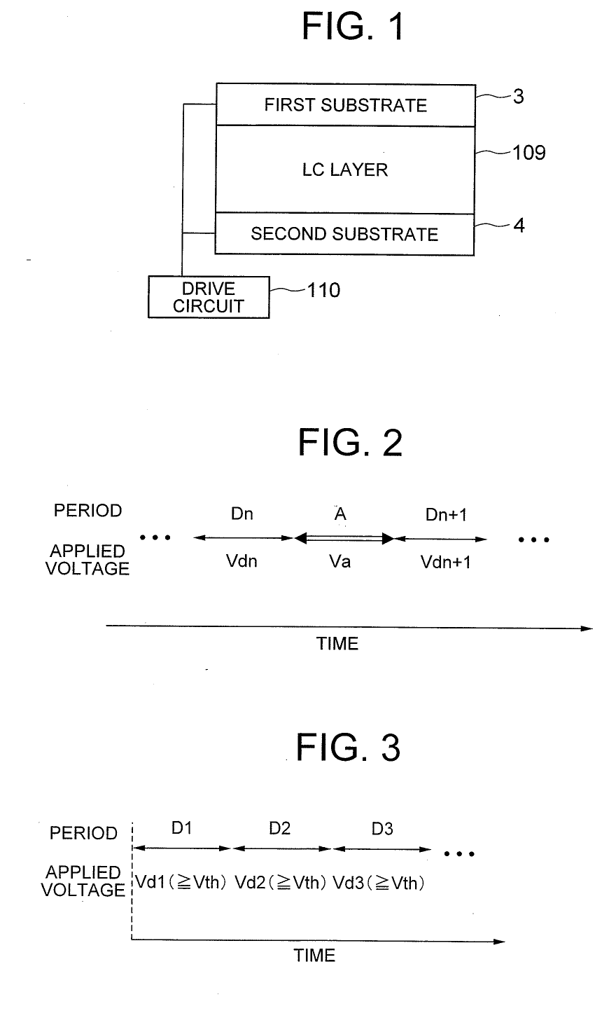

Before describing exemplary embodiments of the present invention, outline of the present invention will be described with reference to accompanying drawings for a better understanding of the present invention. FIG. 1 shows an example of the LCD unit according to the present invention. The LCD unit includes a LC layer 109, and a first substrate 3 and a second substrate 4 sandwiching therebetween the LC layer 109. The LCD unit also includes a drive circuit (drive unit) 110 that supplies a variety of signals to the first substrate 3 and second substrate 4 for driving the LC layer 109. The LC layer 109 is driven in at least a part of the unit pixel by a longitudinal electric field generated between the first substrate 3 and the second substrate 4.

A first example of the configuration of the present invention will be described hereinafter. In the first example of the configuration, the drive circuit 110 provides a preliminary period to a portion of the LC layer that is driven by a longitudinal electric field before an image period wherein an image voltage is applied to the unit pixel in accordance with the image to be displayed. In the preliminary period, the LC layer 109 is applied with a preliminary voltage that is equal to or higher than the threshold voltage. The threshold voltage is a minimum voltage that allows the orientation of LC molecules in the LC layer 109 to start for rotation from the initial orientation. The drive circuit 110 first applies the preliminary voltage to the LC layer 109 during the preliminary period, and then applies to the LC layer 109 an image voltage corresponding to the image to be displayed.

FIG. 2 shows a time chart of the voltage applied to the LC layer 109 in the first example of the present invention. The period in which a single image is displayed is referred to as a unit period. The unit period is equivalent to the period during which all the lines are scanned. Each image period ( . . . , Dn, Dn+1, . . . ) and each preliminary period “A” has a time length equal to the unit period. In the image period ( . . . , Dn, Dn+1, . . . ), the drive circuit 110 outputs an image signal to a signal line, and applies the LC layer 109 with an image voltage ( . . . , Vdn, Vdn+1, . . . ) corresponding to the image to be displayed. The drive circuit 110 applies the preliminary voltage Va that is equal to or higher than the threshold voltage to the LC layer 109 during the preliminary period A.

The preliminary period is inserted between two adjacent image periods. In an alternative, the preliminary period may be provided ahead of the top image period among a plurality of image periods. In the example of FIG. 2, the drive circuit 110 inserts the preliminary period A between an image period Dn of a frame and a subsequent image period Dn+1 of the next frame. The drive circuit 110 applies to the LC layer 109 a voltage Vdn corresponding to the image during the image period Dn, and then applies the preliminary voltage Va to the LC layer 109 during the preliminary period A. Thereafter, the drive circuit 110 applies to the LC layer 109 a voltage Vdn+1 corresponding to the image during the next image period Dn+1. The voltages Vdn and Vdn+1 supplied during the image period may be lower than the threshold voltage.

Next, a second example of the configuration of the present invention will be described. In the second example, the drive circuit 110 maintains the voltage to be applied to a portion of the LC layer 109 applied with the longitudinal electric field during the image period at a voltage equal to higher than the threshold voltage. FIG. 3 shows a time chart showing the voltage applied to the LC layer in the second example. Each image period D1, D2, D3, . . . has a time length equal to the unit period. The drive circuit 110 applies to the LC layer 109 a voltage Vd1, Vd2, Vd3, . . . corresponding to the image to be displayed in each image period D1, D2, D3, . . . . The drive circuit 110 allows the voltage Vd corresponding to the image to be equal to or higher than the threshold voltage.

In the case of a normally white mode, for example, a bright state or white image is obtained by applying a zero volt to the LC layer 109. In the second example, it is assumed that a voltage equal to or higher than the threshold voltage and applied to a portion of the LC layer 109 which is driven by the longitudinal electric field provides a white image. In the case of a normally black mode, a portion of the LC layer 109 applied with a zero volt assumes a dark state, or provides a black image. In the second example, a portion of the LC layer 109 applied with a voltage higher than the threshold voltage provides a black image.

In the second example, it is preferable that the preliminary period be provided ahead of the top image period D1, wherein a voltage equal to or higher than the threshold voltage is applied before application of the voltage Vd1. The thus provided preliminary period is similar to the preliminary period provided in the first example. The preliminary period provided ahead of the top image period D1 may have a plurality of unit periods, i.e., not limited to a single unit period.

The advantage of the LCD unit of each example will be described hereinafter with reference to typical modes including an ECB mode and a VA mode. The ECB mode will be described first. In the LC panel operating in the ECB mode, the second substrate 4 includes a plurality of unit pixels, or a plurality of pixel electrodes. The first substrate 3 includes common electrodes. The LC layer 109 is such that the LC molecules in the LC layer have a positive dielectric anisotropy. The first and second substrates 3 and 4 each include an orientation film in contact with the LC layer 109, whereby the LC layer 109 is homogeneously oriented in the direction parallel to the substrates. The orientation directions of the orientation films on the first substrate 3 and second substrate 4 are parallel to and opposite to each other.

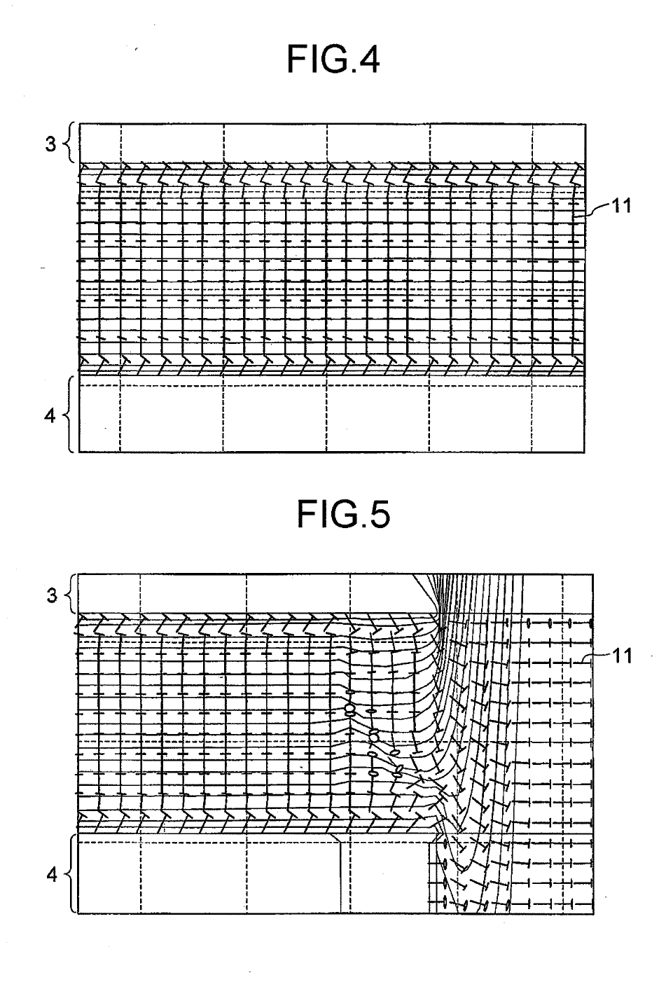

When a potential difference occurs between the pixel electrode and the common electrode to generate a longitudinal electric field between the first substrate 3 and the second substrate 4, the LC molecules in the LC layer 109 rise in the orientation toward the longitudinal direction due to the longitudinal electric field. FIG. 4 shows the orientation direction of LC molecules during application of the longitudinal electric field. Generally, as shown in FIG. 4, the tilt direction of the LC molecules 11 is opposite between the vicinity of the first substrate 3 and the vicinity of the second substrate 4 due to the opposite rubbing directions of the orientation films in the orientation processing. This allows the tilt direction of the LC molecules 11 away from the first substrate 3 to coincide with the tilt direction of the LC molecules 11 away from the second substrate 4, whereby the LC molecules 11 suitably rise within the entire gap between the first substrate 3 and the second substrate 4 without any problem. If the normally white mode is employed, the longitudinal electric field provides a black image.

However, if there occurs an electric field in the LC layer 109 other than the longitudinal electric field, such as a lateral electric field or slanted electric field, the LC molecules existing in the vicinity of the pixel electrode are affected thereby. This may cause a tilt, referred to as reverse tilt, in the direction opposite to the direction of the suitable tilt defined by the rubbing treatment of the orientation films. FIG. 5 shows orientation direction of the LC molecules upon occurring of the reverse tilt. If the reverse tilt such as shown in FIG. 5 occurs, a portion of the LC molecules stays in the lateral direction without a rise in the area where the reverse tilt occurs, although the longitudinal electric field itself is generated.

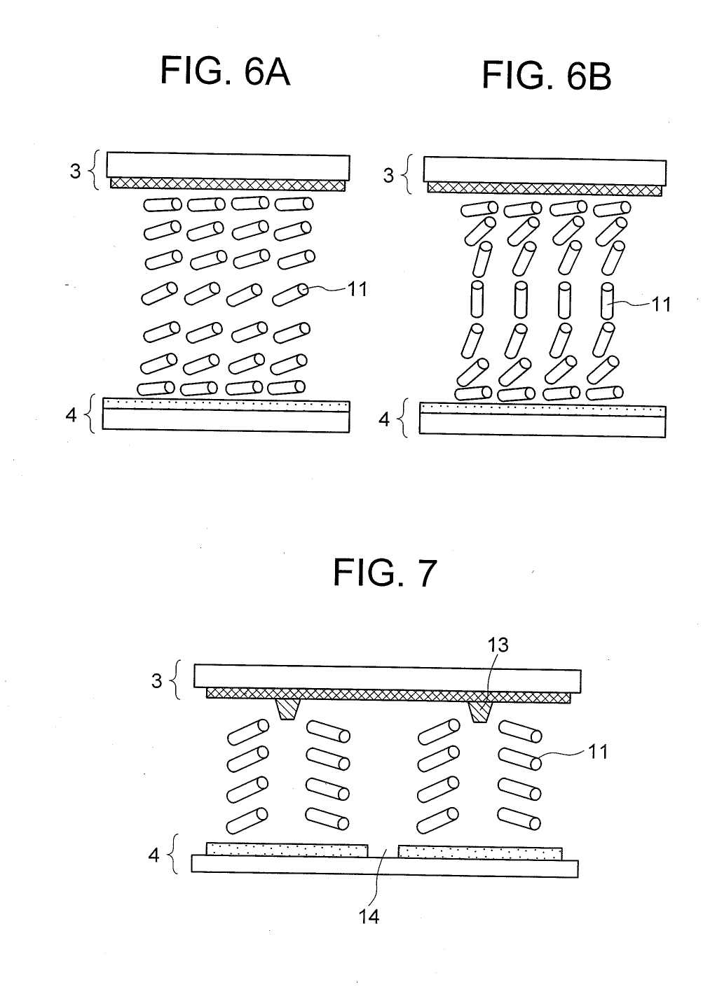

FIG. 6A schematically shows the orientation direction of LC molecules during application of the threshold voltage thereto, whereas FIG. 6B schematically shows the orientation direction of LC molecules during application of the black-image voltage thereto. The black-image voltage as used herein is a voltage that is applied to the LC layer for display of a black image. It is assumed here that the preliminary period is inserted between the image period for display of a white image and the period for display of a black image, as in the first example. In the image period for the white image, LC molecules stay in the direction parallel to the substrates. If a preliminary voltage is applied to the LC layer during the preliminary period, the LC molecules, which have stayed in the direction parallel to the substrates for display of the white image, slightly rise in the direction defined by the rubbing direction in the orientation processing except for the LC molecules in the vicinity of the substrates, as shown in FIG. 6A. After the preliminary period shifts to the image period, wherein a higher voltage is applied for display of the black image, all of the LC molecules rise in the suitable direction defined by the orientation processing irrespective of presence or absence of the lateral electric field in the vicinity of the pixel electrode, as shown in FIG. 6B, because most of the LC molecules have already risen in the suitable direction during the preliminary period. Thus, occurrence of the reverse tilt can be suppressed. Suppression of the reverse tilt can suppress occurrence of the bright line caused by the disclination during display of the black image, whereby a superior image can be obtained.

Next, it is assumed in the second example that the threshold voltage is applied to the LC layer during the image period for display of the white image (referred to as white-image period hereinafter), and then a black image is obtained during a succeeding image period. When the LC layer is applied with the threshold voltage during the white-image period, the LC molecules slightly rise in the direction defined by the orientation processing, as shown in FIG. 6A. Since the voltage applied during display of the white image is the minimum voltage among the applied voltages during the image periods, the LC molecules maintain the suitable direction during the image period without being directed parallel to the substrates. When the white-image period shifts to the black-image period by applying a higher voltage to the LC layer, all of the LC molecules rise in the suitable direction defined by the orientation processing, as shown in FIG. 6B, because most of the LC molecules have already risen slightly to the suitable direction. Thus, occurrence of the reverse tilt can be suppressed. Suppression of the reverse tilt can suppress occurrence of the bright line caused by the disclination during display of the black image, whereby a superior image can be obtained.

The area wherein the LC molecules slightly rise during the preliminary period or white-image period covers the entire area of the pixel electrode including the vicinity thereof as viewed in the direction normal to the substrates. Therefore, even if the reflective area including a reflective film having an uneven surface is driven in the ECB mode, occurrence of the reverse tilt due to the uneven surface of the reflective area can also be suppressed.

It is assumed in the second example that the preliminary period is provided just ahead of the top image period, which corresponds to D1 shown in FIG. 3. Since the LC layer is not applied with a voltage before input of the preliminary voltage, the LC molecules have stayed parallel to the substrates. When the preliminary voltage is applied to the LC layer in this state, the LC molecules slightly rise in the suitable direction defined by the orientation processing, as in the preliminary period of the first example. Due to passing through this state, the LC molecules rise during the image period in the suitable direction defined by the orientation processing after the image voltage corresponding to the image is applied to the LC molecules. Thus, occurrence of the reverse tilt can be suppressed, to thereby suppress occurrence of the disclination.

In the second example of the configuration, wherein the voltage applied to the LC layer is maintained equal to or higher than the threshold during the image period, the orientation of LC molecules is maintained in the state for rising in the suitable direction during the image period, as described above. Thus, provision of the preliminary period that maintains the applied voltage equal to or higher than the threshold voltage ahead of the top image period makes it unnecessary to provide thereafter another preliminary period between the image periods. More specifically, a single preliminary period provided ahead of the top image period is sufficient. Provision of the preliminary period ahead of the top image period D1 (FIG. 3) and provision of the subsequent image periods D1, D2, D3, . . . that applies the LC layer with a voltage equal to higher than the threshold voltage allows the LC molecules to rise in the suitable direction at any time during the image periods, without falling to the lateral direction, and thus maintains the state where the LC molecules can rise in the suitable direction. This suppresses occurrence of the reverse tilt.

Next, description is given to the VA-mode LCD unit. In the LC panel operating in the VA mode, the second substrate 4 includes mainly a plurality of unit pixels or a plurality of pixel electrodes. The first substrate 3 includes a common electrode. The LC molecules in the LC layer 109 have a negative dielectric anisotropy. The first substrate 3 and second substrate 4 each include an orientation film on the surface thereof near the LC layer 109. The orientation films have a function of orienting the LC molecules in the direction normal to the substrates in the initial orientation.

When a potential difference occurs between the pixel electrode and the common electrode, a longitudinal electric field is generated in the LC layer 109, whereby the LC molecules fall toward the direction parallel to the substrates. FIG. 7 shows the orientation of LC molecules during application of the longitudinal electric field. The first and second substrates 3 and 4 include a projection 13 and a slit 14, respectively, on the respective electrodes. Upon application of the longitudinal electric field, the LC molecules 11 uniformly falls to a specific direction while forming a plurality of domains. The state shown in FIG. 7 wherein the longitudinal electric field is applied provides a white image.

As in the case of the ECB mode, when the lateral electric field or slanted electric field other than the longitudinal electric field is applied to the LC layer, the LC molecules are affected thereby so that the direction to which the LC molecules falls differs depending on the domain of the LC molecules. This causes occurrence of the reverse tilt wherein some of the LC molecules stay at the rising state although the longitudinal electric field is applied thereto.

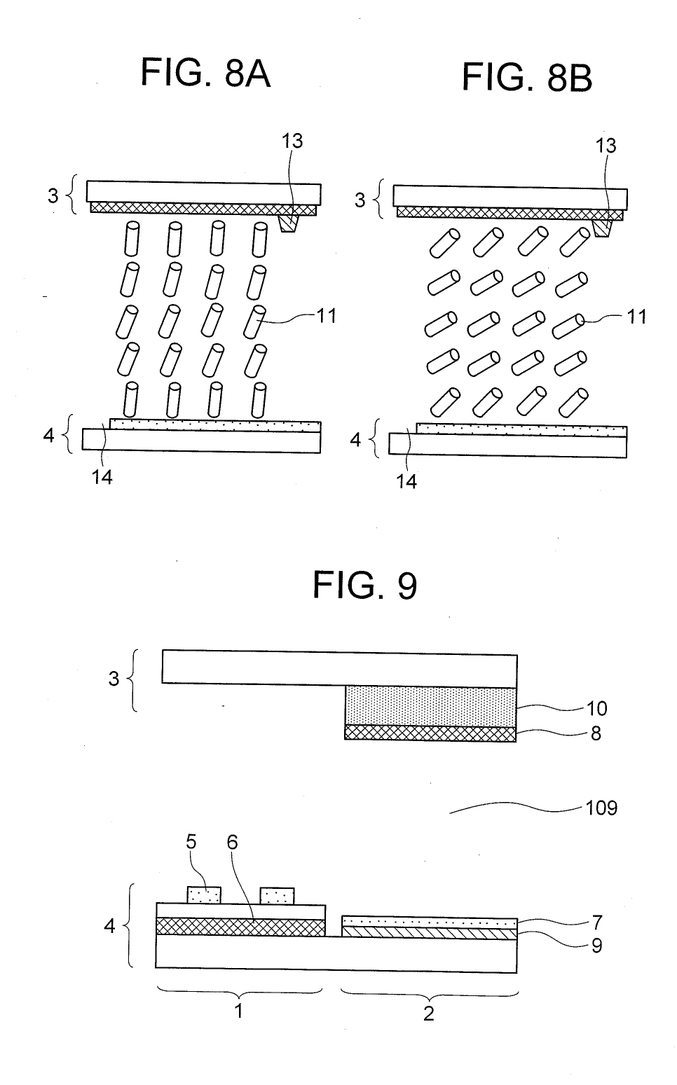

FIG. 8A shows the orientation direction of the LC molecules upon application of the threshold voltage, whereas FIG. 8B shows the orientation direction of the LC molecules upon application of the voltage for display of a white image. First, the first example will be described. It is assumed in the first example that the preliminary period is inserted between the black-image period and the white-image period. In the black-image period, the LC molecules stay perpendicular to the substrates. If the preliminary voltage is applied to the LC layer, the LC molecules, which have stayed perpendicular to the substrates during the black-image period, slightly fall in the suitable direction in accordance with the electric field defined by the presence of the projection 13 or slit 14 except for the LC molecules in the vicinity of the substrates due to the application of the preliminary voltage, as shown in FIG. 8A. Since the orientation of most of the LC molecules have already fallen slightly to the suitable direction during the preliminary period, when a higher voltage is applied to the LC layer for display of the white image, the orientation of LC molecules fall to the direction parallel to the substrates from the slightly fallen state, as shown in FIG. 8B, because the LC molecules are scarcely affected by the lateral electric field occurring in the vicinity of the pixel electrode. This suppresses occurring of the reverse tilt, and thus suppresses occurring of a dark line caused by the disclination during display of the white image. Thus, a superior image can be obtained in the LCD unit.

Next, the second example will be described. It is assumed in the second example that the LC layer is applied with the threshold voltage during the black-image period, and driven to display of a white image during the subsequent image period. When the LC layer is applied with the threshold voltage during the black-image period, the LC molecules slightly fall in the suitable direction in accordance with the electric field defined by the projection 13 and slit 14. Since the voltage applied during the black-image period is the minimum voltage among the voltages applied during the image periods, the LC molecules do not stay in the direction perpendicular to the substrates, and thus maintains the state of falling in the suitable direction. When a higher voltage is applied in order to obtain a white image from the black-image period, all of the LC molecules in the LC layer fall in the suitable direction because most of the LC molecules have already fallen slightly in the suitable direction, as shown in FIG. 8B. Thus, the reverse tilt can be suppressed during these image periods.

The area in which the LC molecules slightly fall in the suitable direction due to application of the threshold voltage during the preliminary period or black-image period covers the entire area of the pixel electrode including the vicinity thereof, as viewed perpendicular to the substrates. Thus, when the reflective area including therein a reflective film having an uneven surface is driven in the VA mode, occurrence of the reverse tilt caused by the uneven surface of the reflective film can be suppressed as well.

It is assumed in the second example that the preliminary period is provided ahead of the top image period corresponding to D1 shown in FIG. 3. Since there is no voltage applied to the LC layer before input of the preliminary voltage, the LC molecules stay perpendicular to the substrates. When the preliminary voltage is applied to the LC layer in this state, the LC molecules slightly fall in the suitable direction in accordance with the direction of electric field defined by the projection 13 or slit 14. After the application of preliminary voltage, the LC layer is applied with a signal voltage corresponding to the image during the image period, the LC molecules fall in the suitable direction. This suppresses occurrence of the reverse tilt, and thus occurrence of the disclination. The advantage obtained by providing the preliminary period ahead of the top image period in the configuration wherein the image period provides an image voltage higher than the threshold is similar to the case of ECB mode.

The LCD unit of the present invention may be a transflective LCD unit that includes a reflective area and a transmissive area. The reflective area includes therein a reflective film having an uneven surface. The reflective area is driven by a longitudinal electric field, whereas the transmissive area is driven by a lateral electric field. FIG. 9 is a sectional view of an example of the LC panel provided in the transflective LCD unit. The transmissive area 1 includes therein a transmissive-area pixel electrode 5 and a transmissive-area common electrode 6 that are formed on the second substrate 4. The reflective area 2 includes therein a reflective film 9 and a reflective-area pixel electrode 7 that are formed on the second substrate 4, and also includes a reflective-area common electrode 8 and a buried retardation film 10 that are formed on the first substrate 3.

The vicinity of the reflective-area pixel electrode 7 is involved with a lateral electric field that is generated between the reflective-area pixel electrode 7 and the transmissive-area common electrodes 6 and may cause occurrence of the reverse tilt. In addition to this lateral electric field, a slanted electric field also occurs in the vicinity of the boundary between the transmissive area 1 and the reflective area 2. More specifically, the slanted electric field is generated between the reflective-area common electrode 8 and the transmissive-area pixel electrode 5 and between the reflective-area common electrode 8 and the transmissive-area common electrode 6. The slanted electric field, which is generated between the opposing electrodes that sandwich therebetween the LC layer 109, exerts the influence on the LC layer 109 to a higher degree compared to the lateral electric field. Thus, the slanted electric field causes occurrence of the reverse tilt to a higher degree.

The LCD unit of the above structure may employ the first configuration wherein the preliminary period is provided ahead of the image period, and the second configuration wherein both the image periods for display of a white image and a black image use a voltage higher than the threshold voltage instead of absence of the applied voltage. By employing the first configuration or second configuration, the LC molecules can be shifted during the image period to a desired orientation from the slightly oriented state in the suitable direction. In this case, if a higher voltage is applied to largely change the orientation of the slightly orientated LC molecules, the LC molecules can be driven in the suitable direction without fail.

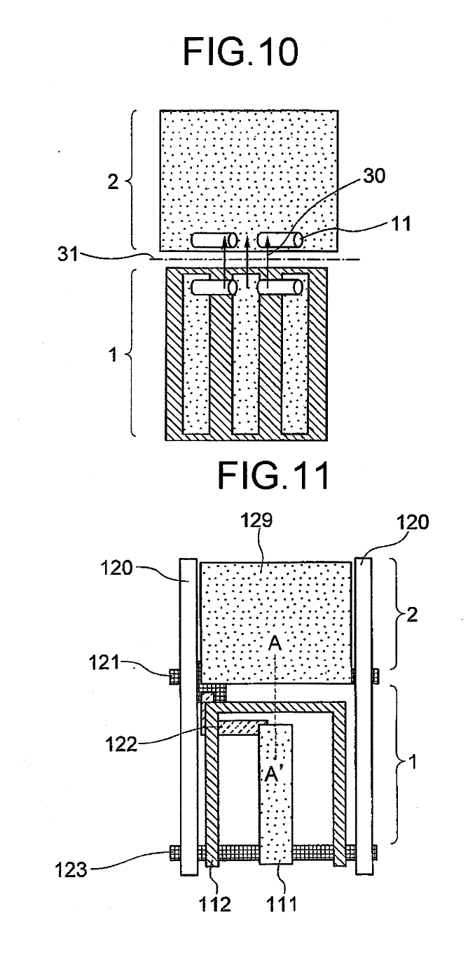

It is preferable in the transflective LCD unit that the initial orientation of LC molecules be directed along the boundary between the transmissive area and the reflective area. FIG. 10 shows a vicinity of the boundary between the transmissive area 1 and the reflective area 2 in a top plan view. The direction of slanted electric field 30 generated on the boundary between the transmissive area 1 and the reflective area 2 is perpendicular to the boundary line 31. If the initial orientation of the LC molecules is parallel to the boundary line 31, the change of orientation of the LC molecules caused by the slanted electric field 30 includes a widening deformation and a narrowing deformation. On the other hand, the change of orientation of the LC molecules caused by the longitudinal electric field between the reflective-area common electrode and the reflective-area pixel electrode is caused by a twist deformation. Therefore, the LC molecules are more likely to be increased in the change of orientation caused by the longitudinal electric, and more likely to be reduced in the change of orientation caused by the slanted electric field, whereby occurrence of the reverse tilt can be suppressed.

Now, exemplary embodiments of the present invention will be described with reference to accompanying drawings, wherein similar constituent elements are designated by similar reference numerals throughout the drawings.

FIG. 11 shows a unit pixel formed in the LC panel of a LCD unit according to a first exemplary embodiment of the present invention. The LCD unit is configured as a transflective LCD unit, wherein each unit pixel includes therein a transmissive area 1 and a reflective area 2. In this embodiment, the transmissive area 1 is driven in the IPS mode, i.e., lateral-electric-field mode, and the reflective area 2 is driven in the ECB mode, i.e., longitudinal-electric-field mode.

The unit pixel is partitioned by data lines 120 and scanning lines 121 that are provided in the entire area of the LC panel as a matrix. The data line 120 is a signal line through which an image signal is transmitted. The scanning line 121 is a signal line through which a scanning signal is transmitted. The vicinity of an intersection of the scanning lines 121 and the data lines 120 is associated with a switching device that corresponds to each unit pixel. The switching device includes a gate electrode, a drain electrode, a source electrode 122, and an amorphous silicon layer. The gate electrode of the switching device is connected to a scanning line 121, whereas the drain electrode is connected to a data line 120.

The transmissive area 1 receives therein a transmissive-area pixel electrode 111 and a transmissive-area common electrode 112. The transmissive-area pixel electrode 111 is connected to the source electrode 122 of the switching device. The transmissive-area common electrode 112 is connected to a transmissive-area common line 123 that is common to the transmissive areas 1 of unit pixels and supplied with a reference potential. In the transmissive area 1, the LC layer is driven by the electric field occurring between the transmissive-area pixel electrode 111 and the transmissive-area common electrode 112.

The reflective area 2 receives therein a reflective-area pixel electrode 129. The reflective area 2 also receives therein a reflective-area common electrode (not shown) that opposes the reflective-area pixel electrode 129 with an intervention of the LC layer, and a reflective film. The reflective-area pixel electrode 129 is connected to the source electrode 122 of the switching device. The reflective-area common electrode is connected to the reflective-area common line that is common to the reflective areas 2 of unit pixels and supplied with a reference potential. In the reflective area 2, the LC layer is driven by the electric field occurring between the reflective-area pixel electrode 129 and the reflective-area common electrode.

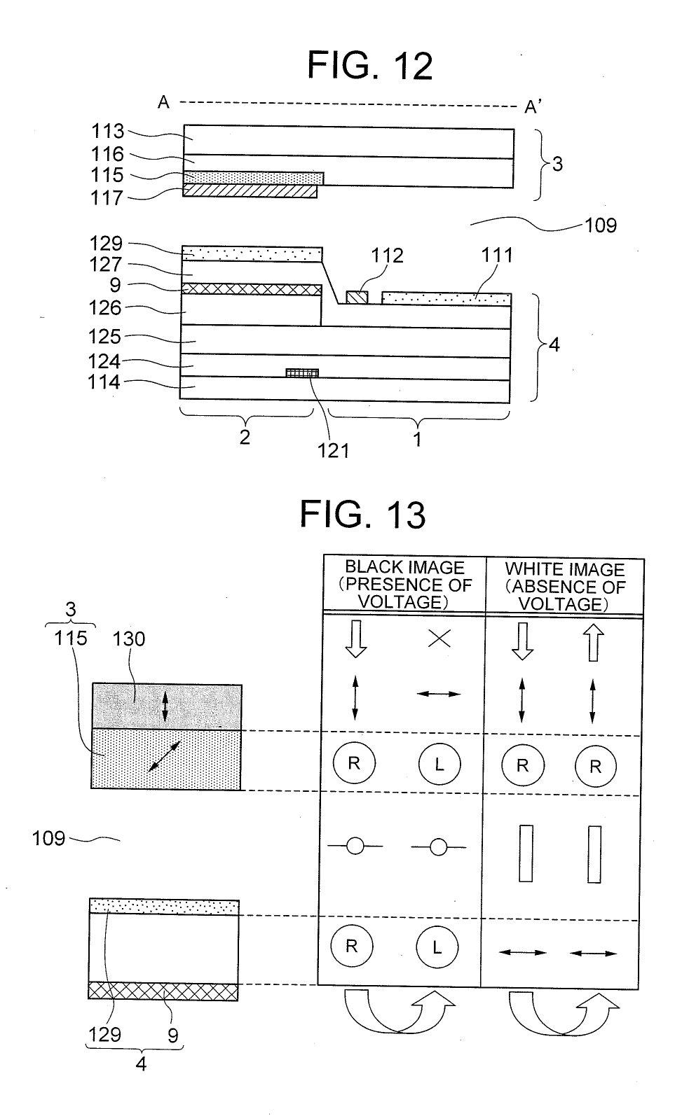

FIG. 12 shows the unit pixel of FIG. 11 taken along line A-A′. The LC panel includes a first substrate 3 and a second substrate 4 opposing each other with an intervention of the LC layer 109. The configuration of second substrate 4 will be described first. The second substrate 4 includes therein drive members having a function of driving the image display members. More concretely, the second substrate 4 includes the scanning line 121, data lines 120 (FIG. 11), transmissive-area pixel electrode 111, transmissive-area common electrode 112, reflective-area pixel electrode 129, switching device etc. The second substrate 4 also includes an orientation film (not shown) that is in contact with the LC layer 109.

On a glass substrate 114 of the second substrate 4, there are provided the scanning lines 121, transmissive-area common lines 123 (FIG. 11), and an insulating film 124. On the insulating film 124, there are provided the data lines 120, the drain electrode and source electrode of the switching device, the amorphous silicon layer, and another insulating film 125. On the insulating film 125, there are provided an uneven film 126 having an uneven surface, and an overlying reflective film 9 in the reflective area 2. Since the reflective film 9 is formed on the uneven film 126 having an uneven surface, the reflective film 9 has an uneven surface. The reflective film 9 reflects external light incident onto the LC panel while diffusing the external light due to the uneven surface.

A planarization film 127 is formed on the reflective film 9. The planarization film 127 may extend toward the transmissive area 1. The uneven film 126 and planarization film 127 also have a thickness adjusting function-for changing the thickness of LC layer 109 in the transmissive area 1 and reflective area 2. The uneven film 126 and planarization film 127 each have a thickness that is adjusted to obtain a desired thickness of the LC layer 109 in each of the transmissive area 1 and reflective area 2.

In the reflective area 2, the reflective-area pixel electrode 129 is formed on the planarization film 127. In the transmissive area 1, the transmissive-area pixel electrode 111 and transmissive-area common electrode 112 are formed on the planarization film 127. The reflective-area pixel electrode 129, transmissive-area pixel electrode 111, and transmissive-area common electrode 112 are formed from a transparent conductor, such as ITO (indium tin oxide). The transmissive-area pixel electrode 111 and transmissive-area common electrode 112 are arranged to extend parallel to and oppose each other, as shown in FIG. 11. In the transmissive area 1, the LC molecules in the layer 109 are driven in the IPS mode, i.e., lateral-electric-field mode by the electric field between the transmissive-area pixel electrode 111 and the transmissive-area common electrode 112.

The configuration of first substrate 3 will be described hereinafter. The first substrate 3 includes therein drive members having a function of driving the image display members. More specifically, the first substrate 3 includes a black-matrix film, i.e., light-shield film, color layers which partially overlap the black-matrix film, transparent planarization film 116, buried retardation film 115, reflective-area common electrode 117, and orientation film which are consecutively arranged from the glass substrate 113 toward the LC layer 109. In FIG. 12, only the buried retardation film 115, planarization film 116, and reflective-area common electrode 117 are illustrated.

The buried retardation film 115 and reflective-area common electrode 117 are formed in the reflective area 2 of the unit pixel. In the reflective area 2, the LC molecules in the LC layer 109 are driven in the ECB mode, i.e., longitudinal-electric-field mode by the electric field occurring between the reflective-area common electrode 117 and the reflective-area pixel electrode 129 that oppose each other with an intervention of the LC layer 109.

The orientation processing, i.e., rubbing treatment is performed to the orientation film formed on the surface of the first substrate 3 near the LC layer, and the orientation film formed on the surface of the second substrate 4 near the LC layer 109. The directions of rubbing treatment performed to both the orientation films are parallel to and opposite to each other. It is preferable that the rubbing direction be parallel to the boundary between the reflective area 2 and the transmissive area 1.

The LC layer 109 is sandwiched between the first substrate 3 and the second substrate 4. The retardation of LC layer 109 is set at about a quarter wavelength of light in the reflective area 2, and set at a half wavelength of light in the transmissive area. The retardation in the reflective area may be larger than the quarter wavelength.

The principle of operation of the LCD unit according to the present embodiment will be described. In the description to follow, it is assumed that the voltage applied to the LC layer for display of the black image or white image is zero volt for simplification of the description. The transmissive-area common electrode 112 and reflective-area common electrode 117 are connected to different signal sources, which feed signals having an inverted-potential relationship therebetween, wherein the potential level of each of the two signals is obtained by inverting the potential level of the other of the two signals. The transmissive-area pixel electrode 111 and reflective-area pixel electrode 129 are connected to a common data line 120 via a switching device, and supplied with a common signal. For example, an arbitrary signal having a potential between 0V and 5V depending on the image to be displayed by the unit pixel is supplied to the transmissive-area pixel electrode 111 and reflective-area pixel electrode 129.

Display of a black image will be described first. When a signal of 0V is supplied to the reflective-area pixel electrode 129 and a signal of 5V is supplied to the reflective-area common electrode 117, the potential difference between the reflective-area pixel electrode 129 and the reflective-area common electrode 117 assumes 5V, whereby the LC layer 109 in the reflective area 2 is driven by a longitudinal electric field generated by this potential difference of 5V. At this stage, the transmissive-area common electrode 112 is supplied with a signal obtained by inverting the potential level of the signal fed to the reflective-area common electrode 117, i.e., supplied with a signal of 0V. Since the signal supplied to the transmissive-area pixel electrode 111 is 0V which is the same as the signal fed to the reflective-area pixel electrode 129, the LC layer 109 in the transmissive area 1 is not applied with an electric field, whereby the LC molecules maintain the initial orientation defined by the orientation processing of the orientation film.

FIG. 13 shows arrangement of layers in the reflective area on the left side of figure, and the change of polarization of light transmitted at respective layers in the reflective area 2 on the right side of figure. The right side of the figure includes a cases of display of two images: a black image (upon presence of applied voltage); and a white image (upon absence of applied voltage). The notation used in the right side of FIG. 13 is such that a thick blank arrow represents the direction of light, a cross represents blocking of light, a thin double arrow represents the polarization direction of a linearly-polarized light or light transmission axis of the polarizing film, “R” encircled represents clockwise-circularly-polarized light, “L” encircled represents counterclockwise-circularly-polarized light, a thick blank bar represents the initial orientation of LC molecules, and a small circle attached with a minor horizontal line represents the raised orientation of LC molecules. The direction of the circularly-polarized light is expressed herein in the state as viewed from the first substrate toward the second substrate.

The horizontal direction in FIG. 13 is referred to as a direction of zero degree, and the vertical direction therein is referred to as a direction of 90 degrees. The depicted layers include a polarizing film 130 having a transmission axis of 90 degrees, the first substrate 3 including the buried retardation film 115 having a retardation of a quarter wavelength and an optical elasticity axis of 45 degrees, LC layer 109, and second substrate 4 including the transparent reflective are pixel electrode 129 and reflective film 9, which are arranged in this order from the external-light incident side of the LCD unit.

In operation of the LCD unit during display of the black image, as shown in “black image” column of FIG. 13, a 90-degree linearly-polarized light is passed by the polarizing film 130, and incident onto the buried retardation film 115. The buried retardation film 115 converts the incident linearly-polarized light into a clockwise-circularly-polarized light, which enters the LC layer 109.

The LC layer 109, which is raised from the initial orientation by the longitudinal electric field, has no refractive index anisotropy at this stage. Thus, the incident light passes through the LC layer 109 as it is, i.e., as the clockwise-circularly-polarized light, to reach the reflective film 9. The light reflected by the reflective film 9 is converted into a counterclockwise-circularly-polarized light, which passes through the LC layer 109 as it is to reach the buried retardation film 115. The light passes through the buried retardation film 115 to be converted into a 0-degree linearly-polarized light having a polarization direction perpendicular to the light transmission axis of 90 degrees in the polarizing film 130. Thus, the light passed by the buried retardation film 115 cannot pass through the polarizing film 130, whereby the LCD unit provides a black image.

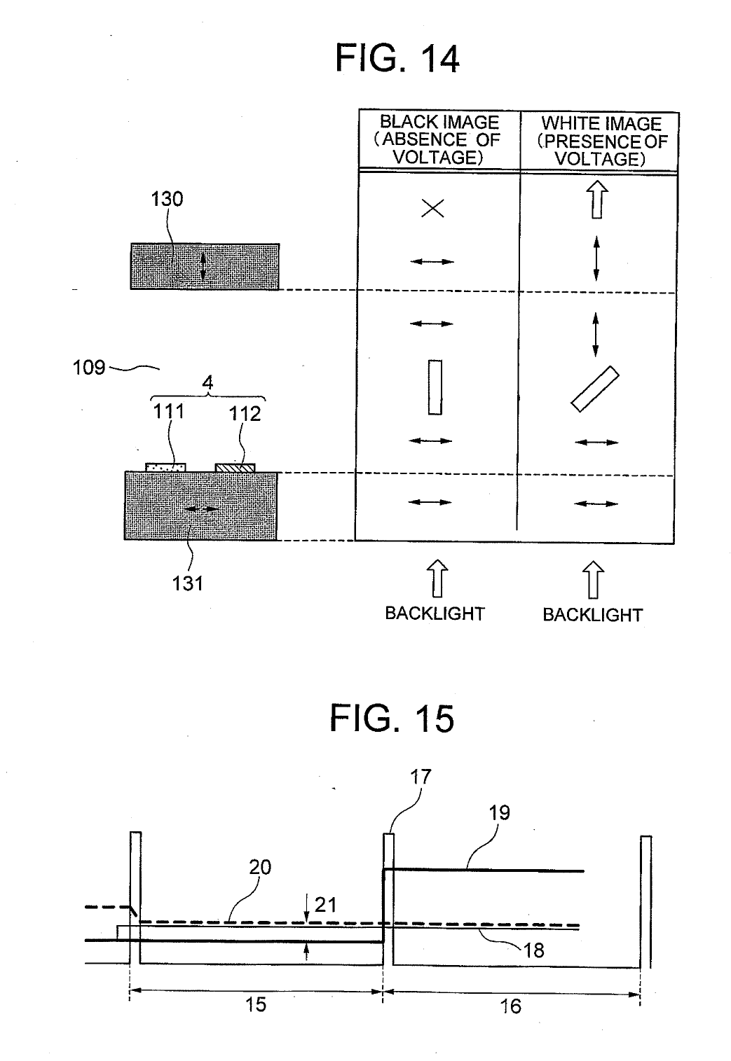

FIG. 14 shows arrangement of layers in the transmissive area 1 on the left side of figure, and the change of polarization of light transmitted at respective layers in the transmissive area 1 on the right side of figure, similarly to FIG. 13. The notation in FIG. 14 is similar to that in FIG. 13. The layers in the transmissive area 1 includes the polarizing film 130 having a light transmission axis of 90 degrees, LC layer 109, second substrate 4 including electrodes 111 and 112, polarizing film 131 having a light transmission axis of 0 degree, and a backlight source (not depicted), which are arranged in the reverse order as viewed from the backlight incident side.

In operation of the LCD unit during display of the black image, as shown in “black image” column of FIG. 14, a 0-degree linearly-polarized light among the backlight emitted from the backlight source is passed by the polarizing film 131, and incident onto the LC layer 109. The LC molecules in the LC layer 109, which has the initial orientation due to absence of the applied voltage between the transmissive-area pixel electrode 111 the transmissive-area common electrode 112, pass therethrough the incident light as it is. The 0-degree linearly-polarized light passed by the LC layer 109 is incident onto the polarizing film 130 having a transmission axis of 90 degrees, and blocked thereby. Thus, the transmissive area 1 provides a black image as well.

Next, operation of the LCD unit during display of a white image will be described. In the reflective area, when the reflective-area pixel electrode 129 and reflective-area common electrode 117 are supplied with a 0-volt signal, there occurs no potential difference between the reflective-area pixel electrode 129 and the reflective-area common electrode 117, whereby the LC molecules of the LC layer 109 in the reflective area maintains the initial orientation defined by the orientation film. At this stage, in the transmissive area, the transmissive-area common electrode 112 is supplied with a signal obtained by inverting the potential level of the signal fed to the reflective-area common electrode 117, i.e., is supplied with a 5-volt signal. Since the transmissive-area pixel electrode 111 is supplied with a 0-volt signal which is the same as the potential fed to the reflective-area pixel electrode 129, a lateral electric field occurs in the transmissive area 1, whereby the LC molecules of the LC layer 109 in the transmissive area rotates in the direction parallel to the substrates.

Operation of the LCD unit in the reflective area will be described with reference to “white image” column of FIG. 13. The incident light, i.e., 90-degree linearly-polarized light, passed by the polarizing film 130 is incident onto the buried retardation film 115, which converts the incident light into a clockwise-circularly-polarized light. This light is incident onto the LC layer 109, as in the case of the black image. Since the LC layer 109 has a retardation of a quarter wavelength, the light incident onto the LC layer 109 is converted into a linearly-polarized light by the refractive index anisotropy of the LC layer 109, and reaches the reflective film 9.

The linearly-polarized light is reflected by the reflective film 9 as it is, and incident onto the LC layer 109, which converts the incident light into a clockwise-circularly-polarized light. This light is incident onto the buried retardation film 115, which converts the incident light into a 90-degree linearly-polarized light. The polarizing film 130 passes therethrough the 90-degree linearly-polarized light, whereby the LCD unit provides a white image.

Operation of the LCD unit in the transmissive area during display of a white image will be described with reference to “white image” column of FIG. 14. A 0-degree linearly-polarized light among the backlight emitted from the backlight source is passed by the polarizing film 131. The LC molecules in the LC layer 109 are rotated by the lateral electric field generated by the potential difference between the transmissive-area pixel electrode 111 and the transmissive-area common electrode 112, to have an optical axis in the direction of 45 degrees. Since the retardation of LC layer 109 in the transmissive area 1 is about a half wavelength, the 0-degree linearly-polarized light passed by the polarizing film 131 is converted into a 90-degree linearly-polarized light by the LC layer 109 having a refractive-index anisotropy. Since the light transmission axis of the polarizing film 130 is at 90 degrees, the light passed by the LC layer 109 passes through the polarizing film 130, whereby the transmissive area 1 provides a white image.

Although the above description includes only the case of display of a white image and a black image, display of intermediate image can be achieved by a similar principle. More specifically, the intermediate image can be obtained by applying a voltage of 0V to 5V between the transmissive-area pixel electrode 111 and the reflective-area pixel electrode 129, for example, depending on the intermediate image (gray-scale level) to be displayed by the unit pixel.

A drive method according to an exemplary embodiment of the present invention will be described. FIG. 15 is a time chart showing the potential of each part in the reflective area. The process of driving the reflective area includes a first step 15 and a second step 16. The first step 15 corresponds to the preliminary period in FIG. 2, whereas the second step 16 corresponds to the image period D1, D2, D3, . . . . It is to be noted that the potential in this figure and other succeeding figures does not corresponds to any actual potential, although the potential of data line during selection of the scanning line is relatively accurate.

At the beginning of first step 15, the potential 17 of scanning line temporally rises, whereby the scanning lines is selected. The drive circuit 110 (FIG. 1) supplies a voltage corresponding to the preliminary voltage to the data line 120, to raise the potential of data line 120 up to the preliminary voltage. This preliminary voltage is written into the reflective-area pixel electrode 129 by the above selection of scanning line, whereby the potential 20 of reflective-area pixel electrode assumes a voltage higher than 0V. At this stage, the potential 19 of reflective-area common electrode is at 0V. In the first step 15, the preliminary voltage 21 that is a potential difference between the potential 20 of reflective-area pixel electrode and the potential 19 of reflective-area common electrode is applied to the LC layer 109.

At the beginning of the second step 16, the potential 17 of scanning line temporarily rises, to select the scanning line. The drive circuit 110 supplies a voltage (image signal) corresponding to an image to the data line 120. The image signal supplied to the data line 120 is written into the reflective-area pixel electrode 129 by the above selection of the scanning line. At this stage, the potential 19 of reflective-area common electrode is at 5V. Thus, a voltage that is the difference between the potential 20 of reflective-area pixel electrode and the potential 19 of reflective-area common electrode is applied to the LC layer 109.

The drive circuit 110 maintains the voltage applied to the LC layer 109 at a voltage higher than the threshold voltage in the second step 16. For example, if the threshold voltage is 1V, the potential difference between the image signal during selection of the scanning line and the reflective-area common electrode is adjusted so that the voltage applied to the LC layer 109 during display of a white image is set at 1V. This adjustment is realizable by providing an offset to the signal input to the reflective-area common electrode.

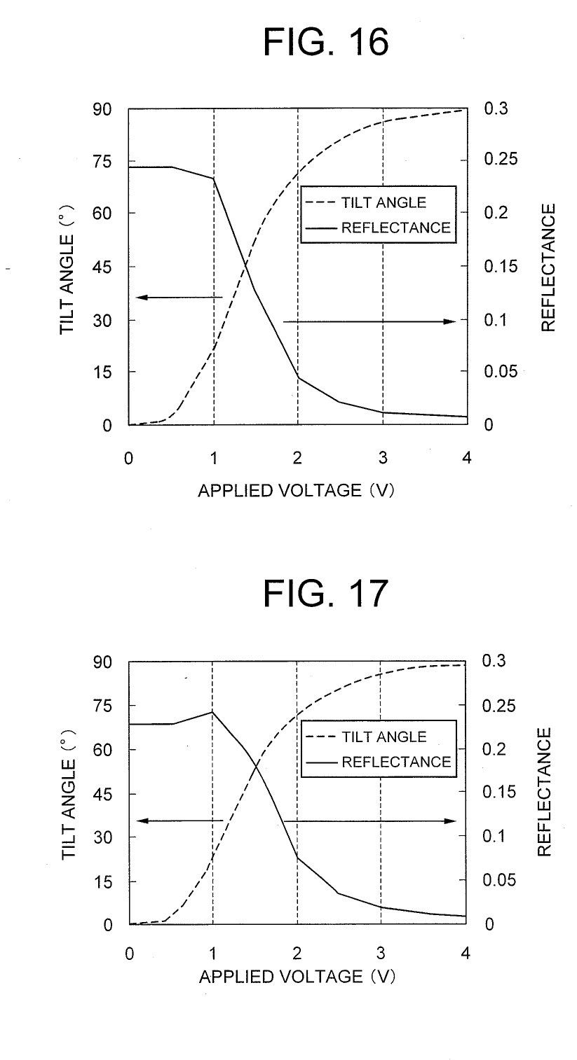

FIG. 16 shows the relationship between the voltage applied to the LC layer in the reflective area and the tilt angle (rise angle) of the LC molecules in the vicinity of the center of the layer as viewed perpendicular to the substrates. FIG. 16 also shows the relationship between the applied voltage and the reflectance in the reflective area. The retardation of LC layer in the reflective area is 137 nm, which is equivalent to a quarter wavelength of light in this example. If the voltage applied to the LC layer reaches about 1V, the tilt angle starts to increase whereby most of the LC molecules slightly rise in the suitable direction defined by the orientation processing. This means the threshold voltage is 1V. In this case, the preliminary voltage applied to the LC layer in the first step 15 (FIG. 15) is 1V, which is equal to the threshold voltage. The voltage applied to the LC layer in the second step 16 is equal to or above 1V.

The preliminary voltage need not be equal to the threshold voltage, and may be higher than the threshold voltage (1V). The minimum voltage applied to the LC layer in the second step 16 need not be equal to the threshold voltage as well, and may be higher than the threshold voltage. It is to be noted however that an excessively higher applied voltage or preliminary voltage may cause the reverse tilt, and thus the applied voltage or preliminary voltage should be a voltage lower than the voltage that cause the reverse tilt. The maximum applied voltage that does not cause the reverse tilt depends on the cell structure and thus is not uniquely determined. The maximum voltage is at least lower than the black-image voltage in the case of a normally white mode.

As understood from FIG. 16, an applied voltage higher than the threshold voltage significantly reduces the reflectance in the reflective area. Since the minimum applied voltage corresponds to the display of white image in the second step 16, an excessively higher value of the minimum applied voltage reduces the brightness of the white image. Thus, it is preferable that the minimum voltage applied to the LC layer in the second step 16 be equal to the threshold voltage. If it is desired that the voltage applied to the LC layer in the second step 16 be higher than the threshold voltage, the minimum applied voltage may be determined based on the desired reflectance during display of the white image.

FIG. 17 shows, similarly to FIG. 16, another example of the relationship between the voltage applied to the LC layer in the reflective area and the tilt angle and reflectance. In this example, the retardation of LC layer in the reflective area is 34 nm larger than the quarter wavelength, 137 nm. In FIG. 17, when the voltage applied to the LC layer substantially reaches 1V, the tilt angle starts to increase, and at the same time the reflectance assumes a maximum.

If the retardation of LC layer is equal to a quarter wavelength of light, and if the white-image voltage is set equal to the threshold voltage at which the tilt angle starts to increase, the reflectance is reduced as compared to the case using a zero volt, as shown in FIG. 16. On the other hand, if the retardation of LC layer is larger than the quarter wavelength, the reflectance assumes a maximum at the threshold voltage at which the tilt angle substantially starts to increase. In this case, the white-image voltage equal to the threshold voltage provides a brighter image. The reason is that setting of the retardation of LC layer to be larger than the quarter wavelength causes the birefringence of the LC layer to reduce along with the slight rise of the LC molecules, whereby the retardation of LC layer assumes the quarter wavelength which is suitable to display of the white image.

In the present embodiment, the voltage applied to a portion of the LC layer, which is driven by a longitudinal electric field, during an image period is maintained at a voltage higher than the threshold voltage at which the orientation of LC molecules start to change in the LC layer. This voltage higher than the threshold voltage and applied during the image period wherein the LC layer is driven in accordance with the gray-scale level allows the LC molecules to rise at least slightly at any time even when the minimum gray-scale voltage is applied. The portion of LC layer driven by the longitudinal electric field is maintained in a state wherein the LC molecules stay in a tilted posture that is suitable to rise in the suitable direction, i.e., not completely fallen to an initial state. This suppresses occurrence of the disclination caused by the reverse tilt.

There is a LCD unit including a reflective area driven in a longitudinal-electric-field mode and a transmissive area driven in a lateral-electric-field mode in each unit pixel, wherein the LC molecules have a low pre-tilt angle for obtaining a wider viewing-angle characteristic in the transmissive area. In such a LCD unit as well, the drive technique described above can be employed, for suppressing the disclination in the reflective area. This allows both the reflective and transmissive areas in the transflective LCD unit to have a superior image quality.

In the present embodiment, a preliminary voltage that is equal to or higher than the threshold voltage is applied prior to the image period to a portion of the LC layer driven in the longitudinal-electric-field mode. Application of the preliminary voltage allows the LC molecules to slightly rise in the suitable direction defined by the orientation processing. The slight rise of the LC molecules allows the LC molecules to significantly rise in the suitable direction when the LC layer is applied with a larger voltage during the initial stage of the image period. This suppresses occurrence of the reverse tilt during the image period succeeding to the preliminary period from the initial stage of the image period. Thus, occurrence of a disclination caused by the reverse tilt can be suppressed.

The structure described in Patent Publication-3 may be applied to a typical transflective LCD unit for providing therein a third electrode. This structure needs provision of a black matrix for shielding light reflected from the third electrode, thereby reducing the effective opening area of the pixel. On the other hand, the present embodiment does not use the third electrode whereby the black matrix is not needed. This does not incur the reduced effective opening ratio of the pixel, and suppresses occurrence of the reverse tilt. In addition, in consideration of the structure of Patent Publication-3 wherein the third electrode can be disposed only in the vicinity of the pixel electrode, the suppression of occurrence of the reverse tilt is achieved only in the periphery of the pixel electrode. In the present embodiment, the suppression of reverse tilt can be achieved in the entire area of the pixel electrode including the vicinity thereof. Thus, the reverse tilt caused by the uneven surface of the reflective film can also be suppressed in the present embodiment.

Next, a LCD unit according to a second exemplary embodiment of the present invention will be described. The LCD unit according to the second exemplary embodiment is similar to the LCD unit of the first exemplary embodiment except for the technique for driving the portion of the LC layer driven in the longitudinal-electric-field mode. In short, the LCD unit of the second exemplary embodiment uses a preliminary period that applies the preliminary voltage equal to or higher than the threshold voltage to the LC layer within an image period that applies a voltage corresponding to an image to the LC layer.

More specifically, the drive circuit 110 (FIG. 1) allows a single frame to include two unit periods: an image period and a preliminary period. Upon switching between frames, the preliminary period in a frame precedes the image period in the succeeding frame, thereby achieving the advantage similar to that obtained in the first exemplary embodiment wherein each preliminary period precedes a corresponding image period in a single frame. In this configuration, the preliminary period at the last stage of a frame allows the LC molecules to slightly rise in the suitable direction, and the image period in the succeeding frame allows the LC molecules to significantly rise in the suitable direction in accordance with the image to be displayed. Thus, the present embodiment suppresses occurrence of the reverse tilt and thus suppresses the disclination, as in the first exemplary embodiment.

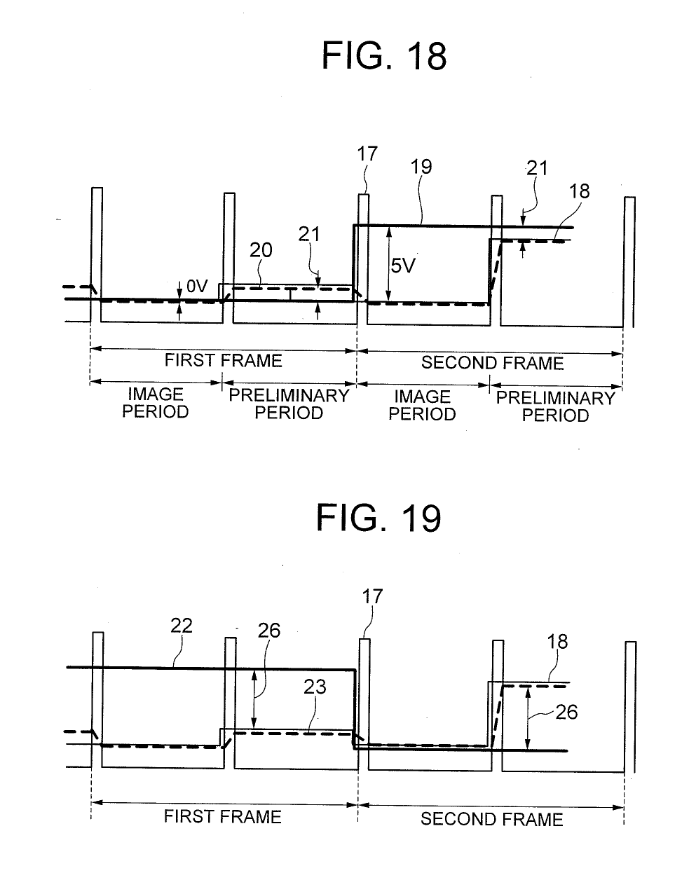

FIG. 18 is a time chart showing the potential change of each part in the reflective area. In this example, each frame, such as a first frame and a second frame, includes an image period preceding to a corresponding preliminary period. It is assumed here that the first frame is a white-image period that provides a white image, and the second image is a black-image period that provides a black image. The reflective-area common electrode has a potential 19 at a zero volt in the first frame, and at 5V in the second frame.

The scanning line has a potential 17 that temporarily rises for selection of the scanning line at the initial stage of the image period and the initial stage of the preliminary period in each frame. Upon the first temporary rise of the potential 17 in the first frame, the drive circuit 110 supplies a voltage (image signal) corresponding to the white image to the data line 120 (FIG. 11), and sets the potential 18 of data line at 0V. This voltage is written into the reflective-area pixel electrode 129 upon selection of the canning line, whereby the potential 20 of reflective-area pixel electrode is set at 0V. In the image period of the first frame, the LC layer 109 is applied with an electric field defined by a potential difference of 0V between the potential 20 of reflective-area pixel electrode and the potential 19 of reflective-area common electrode, whereby the reflective area provides a white image.

Subsequently, the potential 17 of scanning line temporarily rises, for second selection of the scanning line in the first frame. The drive circuit 110 delivers a signal corresponding to the preliminary voltage to the data line 120 at this stage of the second selection of the scanning line, thereby allowing the potential 18 of data line 120 to assume the preliminary voltage. Assuming that the preliminary voltage is 1V, the drive circuit 110 delivers a signal for setting the potential 20 of reflective-area pixel electrode at 1V to the data line 120, because the potential 19 of reflective-area common electrode is at 0V. The potential 18 of data line is written into the reflective-area pixel electrode 129 by the selection of scanning line, whereby potential 20 of reflective-area pixel electrode is set at 1V. In the preliminary period of the first frame, the LC layer 109 is applied with an electric field defined by the preliminary voltage 21 (1V) that is the difference between the potential 20 of reflective-area pixel electrode and the potential 19 of the reflective-area common electrode, whereby the LC molecules slightly rises in the suitable direction defined by the orientation processing.

The process then advances to the second frame wherein the potential 17 of scanning line temporarily rises at the initial stage, for a first selection of the scanning line. The drive circuit 110 supplies a voltage corresponding to the black image to the data line 120, to allow the potential 18 of data line to assume a voltage corresponding to the black image. Since the potential 19 of reflective-area common electrode is 5V, the drive circuit 110 delivers a signal for setting the potential 20 of reflective-area pixel electrode at 0V to the data line 120. The potential 18 of data line is written into the reflective-area pixel electrode 129 due to the first selection of scanning line. In the image period of the second frame, 5V which is a difference between the potential 20 of reflective-area pixel electrode and potential 19 of the reflective-area common electrode is applied to the LC layer 109, whereby the reflective area provides a black image.

Subsequently, the potential 17 of scanning line temporarily rises in the second frame, for second selection of the scanning line in the second frame. At this stage of second selection of the canning line, the drive circuit 110 delivers a signal having the preliminary voltage to the data line 120, and allows the potential 18 of data line to assume the preliminary voltage. Since the potential 19 of reflective-area common electrode in the second frame is 5V, assuming that the preliminary voltage is 1V, the drive circuit 110 delivers to the data line 120 a signal for setting the potential 20 of reflective-area pixel electrode at 4V. The potential 18 of data line is written into the reflective-area pixel electrode 129 due to second selection of the scanning line. The preliminary period of the second frame applies to the LC layer 109 the preliminary voltage 21 (1V) which is a difference between the potential 20 of reflective-area pixel electrode and the potential 19 of reflective-area common electrode, whereby the LC molecules slightly rise in the suitable direction defined by the orientation processing.

In FIG. 18, a white image is displayed during the image period of the first frame, and thereafter the preliminary voltage is applied during the preliminary period, to allow the LC molecules to slightly rise, followed by the second frame for display of the black image. The preliminary period sandwiched between both the image periods providing the white image and the black image in this way allows the LC molecules to slightly rise before a significant rise during the image period. This allows the black image provided in the second frame to suppress occurrence of the disclination cause by the reverse tilt.

Although each frame in FIG. 18 includes the preliminary period succeeding to the image period, the order of these periods may be reversed from the above embodiment. More specifically, the configuration may be such that the first selection of scanning line in each frame delivers a signal corresponding to the preliminary voltage to the reflective-area pixel electrode 129 and the second selection of scanning line in each frame delivers a signal corresponding to the image to be displayed. In this case as well, the process shifts from the image period for a white image in the first frame to the image period for a black image in the second frame, thereby achieving the advantage similar to that described above.

FIG. 19 is a time chart showing the potential of each part in the transmissive area. The potentials 17 and 18 of the scanning line and data line are similar to those shown in FIG. 18. The change of potential 23 of transmissive-area pixel electrode in FIG. 19 is similar to the change of potential 20 of reflective-area pixel electrode in FIG. 18. Since the common electrodes in the reflective and transmissive area are applied with common signals having therebetween an inverted-potential relationship, the potential 22 of the transmissive-area common electrode is obtained by inverting the level of potential 19 of reflective-area pixel electrode. Thus, the potential 22 of transmissive-area common electrode is at 5V in the first frame, and at 0V in the second frame.

In the reflective area, the LC molecules slightly rise from the initial orientation during the preliminary period, whereby the reflective area provides a substantially white image. In the transmissive area, the voltage 26 applied to the LC layer during the preliminary period is reduced from the previous period by the preliminary voltage, whereby the preliminary period provides a substantially white image. In this configuration, the image in both the reflective area and transmissive area shifts from a white image (image period), via a substantially white image (preliminary period) and a black image (image period) to a substantially white image (preliminary period). This image shift including the substantially white image between the white-image periods may reduce the contrast ratio to some extent. In particular, the transmissive area experiences a somewhat larger reduction in the contrast ratio because the transmissive area inherently has a larger difference between the black-image brightness, i.e., brightness during display of the black image and the white-image brightness, i.e., brightness during display of the white image.

For reducing the degree of reduction in the contrast ratio, it is effective for the transmissive area to change the image displayed during the preliminary period from the white image to a black image. This is achieved by, for example, allowing the voltage applied to the LC layer in the transmissive area during the preliminary period to be equivalent to the voltage applied to the LC layer in the reflective area. As described before, the signal supplied to the transmissive-area common electrode and the signal supplied to the reflective-area common electrode have therebetween an inverted-potential relationship. Thus, the signal supplied to the transmissive-area common electrode during the image period is inverted and supplied to the transmissive-area common electrode during only the preliminary period. This allows the transmissive-area common electrode to be equipotential to the signal supplied to the reflective-area common electrode, whereby the voltage applied to the LC layer in the transmissive area is equivalent to the voltage applied to the LC layer in the reflective area during only the preliminary period.

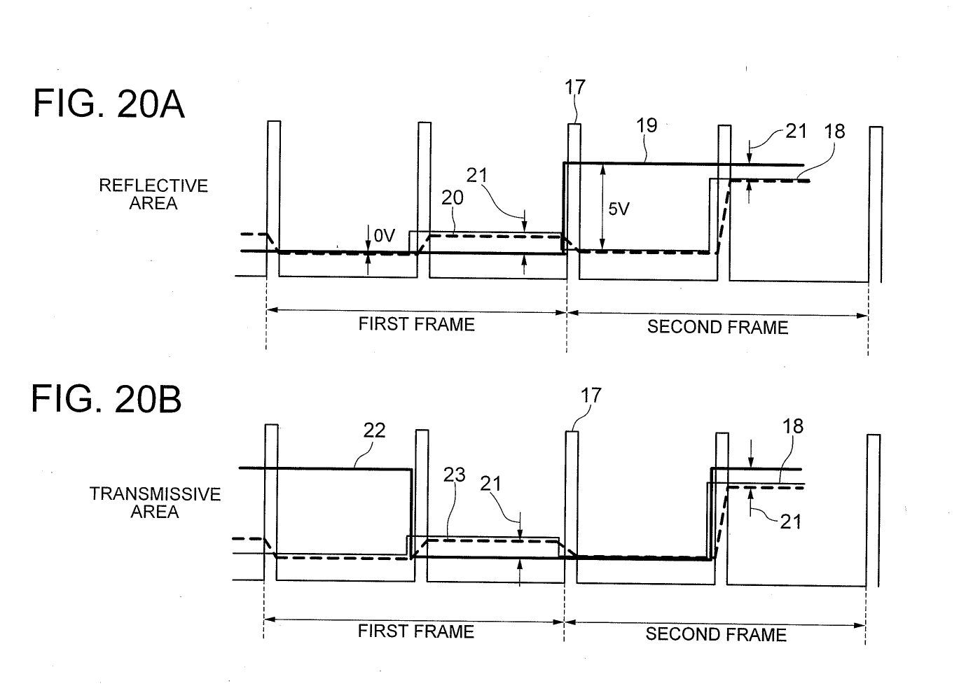

FIGS. 20A and 20B are time charts showing the potential of each part in the reflective area and transmissive area, respectively, in the case of inverting the potential level of transmissive-area common electrode during the preliminary period. The potential change of each part in the reflective area shown in FIG. 20A is the same as the potential change shown in FIG. 18. In the transmissive area, the potential 22 of transmissive-area common electrode is reversed in each frame upon shifting from the image period to the preliminary period. That is, during the preliminary period (i.e., second scanning period) of the first frame, the potential 22 of transmissive-area common electrode is changed to 0V from 5V that is the potential of transmissive-area common electrode during the image period. In the preliminary period of the second frame, the potential 22 of transmissive-area common electrode is changed to 5V from the potential, 0V, of transmissive-area common electrode during the image period.

The above control of the potential 22 of transmissive-area common electrode allows the voltage applied to the LC layer in the preliminary period in the transmissive area to be equivalent to the preliminary voltage 21 applied in the reflective area, whereby the transmissive area provides a substantially black image during the preliminary period. More specifically, the image of the transmissive area changes from a white image (image period), via a substantially black image (preliminary period), and a black image (image period) to a substantially black image (preliminary period). The average brightness during the second frame shown in FIG. 20B is lower than the average brightness shown in FIG. 19 wherein the potential of transmissive-area common electrode is not inverted. Thus, the contrast ratio of the white image provided in the first frame to the black image provided in the second frame is improved in FIG. 20B as compared to FIG. 19.

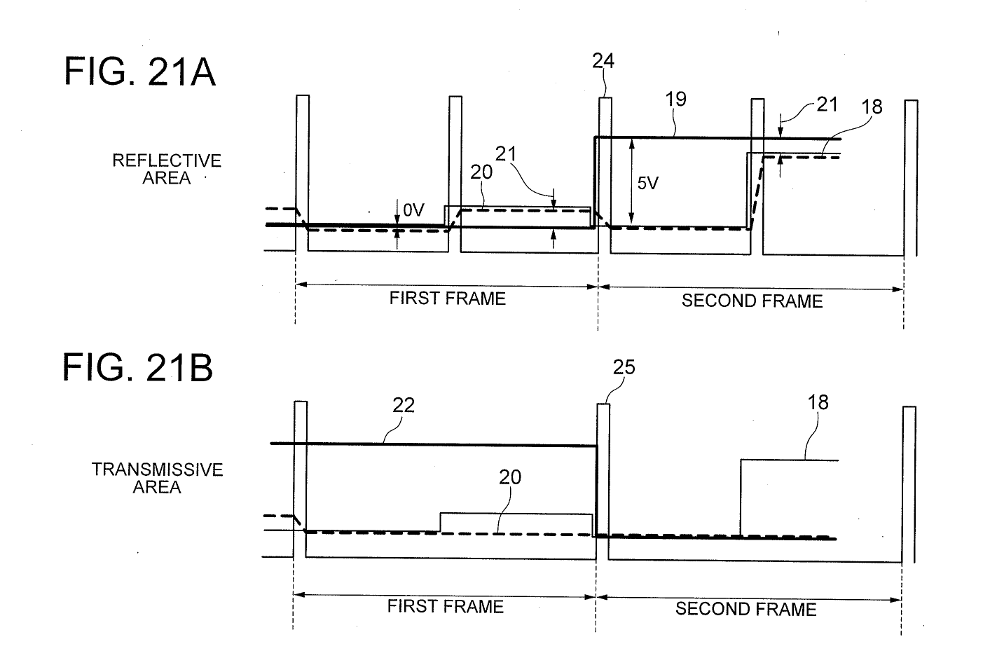

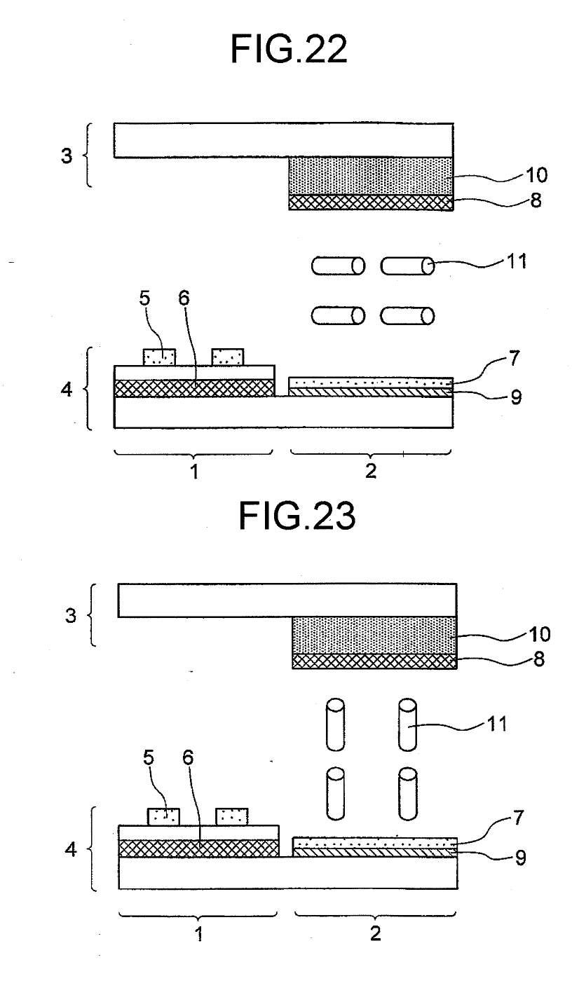

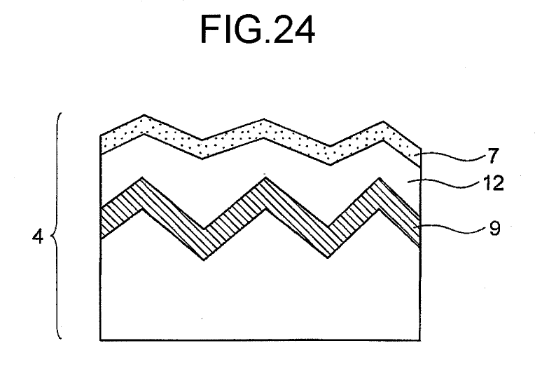

In an alternative, the contrast ratio of the transmissive area may be improved by absence of the preliminary period in the transmissive area. FIGS. 21A and 21B are time charts showing the potential of each part in the reflective area and transmissive area, respectively, in this case. The scanning line includes a scanning sub-line for the transmissive areas separately from a canning sub-line for the reflective areas. In each frame, a first scan is performed in both the transmissive area and reflective area. A second scan is performed only in the reflective area without performing in the transmissive area. More specifically, the first scan for the image period is performed by temporarily raising the potential 24, 25 of both the scanning sub-lines for writing the image signal, whereas the second scan for the preliminary period is performed by temporarily raising only the potential 24 of the scanning sub-line for the reflective area. This configuration provides an ordinary image wherein the preliminary voltage is not applied in the transmissive area, thereby preventing degradation of the image quality in the transmissive area.

In the present embodiment, a portion of the LC layer driven by the longitudinal electric field is applied with the threshold voltage during the preliminary period and then applied with the voltage corresponding to the image displayed during the image period. The preliminary period allows the LC molecules to slightly rise, whereby the subsequent image period allows the LC molecules to significantly rise in the suitable direction. Thus, the disclination caused by the reverse tilt can be suppressed. In a design of the LCD unit that includes in each unit pixel a reflective area driven by the longitudinal electric field and a transmissive area driven by the lateral electric field, the LC molecules sometimes stay in the orientation of a lower pre-tilt angle for obtaining a wider viewing-angle characteristic. In such a LCD unit as well, the drive technique as described above prevents occurrence of the disclination in the reflective area, whereby a transflective LCD unit having a superior image quality in both the transmissive area and reflective area is provided.

In the second exemplary embodiment, each frame includes the preliminary period. However, the present invention is not limited to such an example. More specifically, it is not needed for all the frames to include therein the preliminary period, and it is sufficient that one of several frames include the preliminary period. In other words, a frame including the preliminary period and another frame including no preliminary period may be mixed in the drive of LCD unit. In such a case as well, the reverse tilt can be suppressed in the image period succeeding to the preliminary period. In a further alternative, it is not needed for each frame to include both the image period and preliminary period, and it is sufficient that a frame including only the preliminary period be inserted between adjacent frames each including only the image period.

While the invention has been particularly shown and described with reference to exemplary embodiment thereof, the invention is not limited to these embodiments and modifications. As will be apparent to those of ordinary skill in the art, various changes may be made in the invention without departing from the spirit and scope of the invention as defined in the appended claims.

1. A liquid crystal display unit (LCD) comprising:
a liquid crystal (LC) layer;
first and second substrates sandwiching therebetween said LC layer to define an array of unit pixel; and
a drive unit that drives said LC layer in at least a part of said unit pixel by applying thereto a longitudinal electric field generated between said first substrate and said second substrate, wherein:
said drive unit drives said at least a part of said unit pixel in an image period by applying thereto an image voltage corresponding to an image, and in a preliminary period preceding to said image period by applying thereto a preliminary voltage equal to or higher than a threshold voltage that allows LC molecules in said LC layer to start change of orientation of said LC molecules.

2. The LCD unit according to claim 1, wherein said drive unit inserts said preliminary period between adjacent two of said image period.

3. A liquid crystal display unit (LCD) comprising:
a liquid crystal (LC) layer;
first and second substrates sandwiching therebetween said LC layer to define an array of unit pixel; and
a drive unit that drives said LC layer in at least a part of said unit pixel by applying a longitudinal electric field generated between said first substrate and said second substrate, wherein:
said drive unit drives said at least a part of said unit pixel in an image period by applying thereto an image voltage corresponding to an image, and maintains in said image period a voltage applied to said at least a part of said unit pixel at a threshold voltage that allows LC molecules in said LC layer to start change of orientation of said LC molecules or higher than said threshold voltage.

4. The LCD unit according to claim 3, wherein said drive unit applies a preliminary voltage equal to or higher than said threshold voltage to said at least a part of said unit pixel when said LC molecules shift from an initial orientation to a state in said image period.

5. The LCD unit according to any one of claims 1 to 4, wherein said unit pixel includes a reflective area that includes therein a reflective film having an uneven surface, and said drive unit drives said reflective area as said at least a part of said unit pixel.

6. The LCD unit according to any one of claims 1 to 4, wherein said unit pixel further includes, other than said at least a part of said unit pixel, a first area that is driven by a lateral electric field that is parallel to said first and second substrates.

7. The LCD unit according to claim 6, wherein said unit pixel includes a transmissive area as said first area, and a reflective area as said at least a part of said unit pixel.

8. The LCD unit according to claim 7, wherein some of said LC molecules have an initial orientation directed along a boundary between said transmissive area and said reflective area.

9. The LCD unit according to claim 7, wherein said reflective area includes therein reflective-area common electrode, and said transmissive area includes therein a transmissive-area common electrode connected to a signal source that is different from a signal source connected to said reflective-area common electrode.

10. The LCD unit according to claim 1, wherein:
said unit pixel includes a reflective area as said at least a part of said unit pixel, and a transmissive area driven by a lateral electric field;
said reflective area includes therein reflective-area common electrode, and said transmissive area includes therein a transmissive-area common electrode connected to a signal source that is different from a signal source connected to said reflective-area common electrode; and
said reflective-area common electrode and said transmissive-area common electrode are supplied with different drive signals having therebetween an inverted-potential relationship during said image period, and supplied with a common drive signal during said preliminary period.

11. The LCD unit according to claim 1, wherein:
said unit pixel includes a reflective area as said at least a part of said unit pixel, and a transmissive area driven by applying a lateral electric field;
said reflective area includes therein reflective-area common electrode, and said transmissive area includes therein a transmissive-area common electrode connected to a signal source that is different from a signal source connected to said reflective-area common electrode;
said drive circuit includes a first scanning line for said reflective area and a second scanning line for said transmissive area; and
said drive circuit scans both said first and second scanning lines during said image period and scans said second scanning line during said preliminary period.

12. A terminal device comprising the LCD unit according to any one of claims 1 to 4.

13. A method for driving a liquid crystal display unit that includes first and second substrates sandwiching therebetween a liquid crystal (LC) layer and define an array of unit pixel, said method comprising:
driving the LC layer in at least a part of the unit pixel by applying thereto a longitudinal electric field generated between the first substrate and the second substrate; and
driving said at least a part of the unit pixel in an image period by applying thereto an image voltage corresponding to an image, and in a preliminary period preceding to said image period by applying thereto a preliminary voltage equal to or higher than a threshold voltage that allows LC molecules in the LC layer to start change of orientation of said LC molecules.

14. A method for driving a liquid crystal display unit that includes first and second substrates sandwiching therebetween a liquid crystal (LC) layer and define an array of unit pixel, said method comprising:
driving the LC layer in at least a part of the unit pixel by applying thereto a longitudinal electric field generated between the first substrate and the second substrate, wherein:
driving said at least a part of the unit pixel in an image period by applying thereto an image voltage corresponding to an image; and
maintaining in said image period a voltage applied to said at least a part of the unit pixels at a threshold voltage that allows LC molecules in the LC layer to start change of orientation of said liquid crystal molecules or higher than said threshold voltage.
